(19) United States
(12) Patent Application Publication
(10) Pub. No.: US 2024/0109716 A1
(43) Pub. Date: Apr. 4, 2024

(54) EXTRACTING AND DOSING VALVE FOR A DEVICE FOR DISCHARGING SPRAY MEDIA

(71) Applicant: iSi GmbH, Wien (AT)

(72) Inventors: Wojciech MASZCZYK, Kleinebersdorf (AT); Daniel Manojlovic, Wien (AT)

(21) Appl. No.: 18/366,449

(22) Filed: Aug. 7, 2023

(30) Foreign Application Priority Data
Sep. 29, 2022 (EP) 22198719.1

(51) Int. Cl. B65D 83/54; A47J 43/12; B65D 83/48

(52) U.S. Cl. CPC B65D 83/54; A47J 43/128; B65D 83/48

(57) ABSTRACT

The invention relates to an extracting and dosing valve for a device for discharging spray media, comprising: an extraction piston having a longitudinal axis that comprises an extraction-piston actuating region and an axially oppositely arranged extraction-piston end region; an extraction orifice comprising a passage opening in which the extraction piston is arranged so as to be movable linearly, the extracting and dosing valve having a closed state that corresponds to a defined position of the extraction piston; and a first sealing element arranged adjoining the extraction-piston end region on the actuating region side, wherein the first sealing element closes the passage opening when the extracting and dosing valve is in the closed state.

### REFERENCE TO RELATED APPLICATION

This application claims priority to European Patent Application No. 22 198 719.1 filed on Sep. 29, 2022, the entirety of which is incorporated by reference herein.

### FIELD OF THE INVENTION

The present invention relates to an extracting and dosing valve, to a head for a device for discharging spray media comprising such extracting and dosing valve, and to a device for discharging spray media.

### BACKGROUND TO THE INVENTION

Document AT 502 472 B1 discloses a device for producing and extracting liquid or foamy foodstuffs, comprising a pressure container, a head, which can be arranged on the pressure container and acts as a lid, having a receiver for gas capsules. The container in this case is first filled with the respective foodstuff to be sprayed and is then closed with the head. This foodstuff, or the medium to be sprayed, is present in the container in liquid form. As a result of a gas being introduced into the interior of the appliance, or container, from a gas capsule, the pressure in the interior of the container increases in such a way that the gas particles are dissolved in the foodstuff, and this process can be accelerated by shaking the device. As a result, upon extraction of the foodstuff, foaming occurs, or the foodstuff is transformed to a creamy, or foamy, or sauce-like state. Extraction through a valve bore is effected with the aid of a push-button that is connected to a valve plunger for dosing the foamed foodstuff to be dispensed, an arrangement composed of a sealing surface and a sealing element being provided for closing the valve bore.

This gives rise to the problem that ease of handling with constant delivery of the medium to be sprayed, in particular with non-constant pressure conditions within the device, can only be achieved with a great deal of practice. Also, an extracting and dosing valve required for dispensing the medium to be sprayed cannot be easily cleaned, as the seal of the extracting valve is built into the head.

There is a desire to overcome the problems described above by making the extracting and dosing valve removable for cleaning, while ensuring optimum dosing capability. In this case, venting of the pressure vessel is to be ensured during separation of the head from the pressure vessel, while any uncontrolled escape of the medium from the pressure vessel is to be prevented when the extracting and dosing valve is being separated from the head.

### SUMMARY

An extracting and dosing valve for a device for discharging spray media is provided. The extracting and dosing valve comprises an extraction piston having a longitudinal axis that comprises an extraction-piston actuating region and an axially oppositely arranged extraction-piston end region, and an extraction orifice comprising a passage opening in which the extraction piston is arranged so as to be movable linearly, the extracting and dosing valve having a closed state that corresponds to a defined position of the extraction piston. The extracting and dosing valve further comprises a first sealing element, such as realized in the form of an O-ring, arranged adjoining the extraction-piston end region on the actuating region side, wherein the first sealing element closes the passage opening when the extracting and dosing valve is in the closed state. The longitudinal displaceability of the extraction piston offers the advantage that it can be removed from the device, making the extraction piston and the extracting and dosing valve easy to clean.

When the extracting and dosing valve, which can be regulated by means of an actuating element arranged on the extraction-piston actuating region, is in the closed state, at least part of the extraction-piston end region is located within the passage opening, thus enabling the valve to be manufactured easily with a simple structure. This also ensures that, in the event of a failure of the extracting and dosing valve, the spray medium emerges slowly and not abruptly.

It is to be noted that the extracting and dosing valve, in addition to having the closed state also has, of course, an open state, which likewise corresponds to a corresponding longitudinal position of the extraction piston, and it may be provided that there are a multiplicity of open states that correspond to different longitudinal positions of the extraction piston and in which spray medium can pass through the extracting and dosing valve to a different extent in each case. It is also provided that the extracting and dosing valve furthermore has a venting position in which the extraction piston can be freely removed for cleaning the extracting and dosing valve.

In detail, the passage opening is delimited radially outwardly by a sealing surface on the actuating element side and by an extraction surface axially adjoining axially it on the discharge side, which together form an inner surface of the extraction orifice, the first sealing element bearing at least partially against the sealing surface when the extracting and dosing valve is in the closed state, thereby ensuring tightness of the extracting and dosing valve and longer durability of the spray medium to be discharged, even when the device is not in use.

It may be provided in this case that the sealing surface arranged on the actuating element side has a lesser cross-sectional area than the extraction surface arranged on the discharge side. Such a conical, or tapered, design of the inner surface ensures the tightness of the valve based on an extraction piston, the outflow behavior, or the flow rate, of the spray medium also being regulable in dependence on the position of the extraction piston, or the setting of the actuating element, and easier cleaning can be achieved.

Here, in one embodiment, both the sealing surface and the extraction surface of the extraction orifice, as well as the extraction piston, have the same cross-sectional shape, which is preferably rotationally symmetrical, thus ensuring greater ease of manufacture. Alternatively, different cross-sectional shapes may be realized.

In detail, the extraction surface is preferably conical or conically domed or conically convex for the purpose of regulating a flow of the spray medium between the passage opening and the extraction piston, resulting in the advantage that the user, when handling the device, can control the flow of the spray medium by exerting force or pressure on the actuating element. Moreover, there is the advantage that a simple sealing of the extracting and dosing valve can be realized by means of the first sealing element arranged on the extraction piston.

Here, to facilitate mounting of the first sealing element, the extraction-piston end region is preferably conical, thereby enabling the first sealing element, which is preferably realized as an O-ring, to be rolled onto, or over, the rod-shaped extraction piston, the first sealing element, in order for it to be fixed in position, being arranged in an extraction-piston groove that adjoins the extraction-piston end region and that is preferably realized in the form of a trapezoidal groove. It is than also provided that the outer diameter of the first sealing element is greater than the smallest diameter of the sealing surface of the extracting orifice, thereby ensuring sealing of the extracting and dosing valve. The first sealing element in this case is made of elastomer, preferably vulcanized synthetic rubber, in order to achieve a highest possible, or sufficiently good, sealing.

For extracting highly viscous media and for more precise regulation of the flow of the spray medium, the extraction surface of the extraction orifice comprises at least one recess, preferably three recesses offset by 120 degrees, thereby making it possible to realize a targeted discharge of a spray medium having a higher viscosity, or of a spray medium mixed with solid particles or solids. In this case, in one embodiment, the recess(es) is/are flat or slot-shaped or cylindrical, the extraction piston is rod-shaped, cylindrical or spindle-shaped. By means of such differently designed recesses, control of the flow rate of the spray medium by the extracting and dosing valve can be realized during operation of the device.

In an embodiment, the extraction piston comprises a guide portion arranged on the extraction-piston actuating-region side, there being arranged, between the extraction-piston end region and the guide portion, a dosing portion on the extraction-piston end-region side and a flow braking portion on the guide-portion side, as a result of which, even upon maximum actuation of the actuation element, no greater, or lesser, flow rate than the maximum flow rate predefined by a diameter of the extraction piston can be realized. This prevents an abrupt outflow of the spray medium if the device is actuated excessively, in particular too forcefully, or an unnecessarily high flow rate when the extracting and dosing valve is fully opened, in particular at a high pressure.

To ensure a targeted discharging of the spray medium, in one design the dosing portion is tapered conically or in a curved manner toward the guide portion, the guide portion being cylindrical or rod-shaped, thereby enabling the spray medium to be discharged in a targeted manner at a particular flow rate in dependence on a location, or positioning, of the extraction piston in the extracting and dosing valve. In other words, different flow rates can be set in dependence on the positioning of the extraction piston, and different volume flows, or discharges, of the spray medium can also be realized by means of differently designed geometries of the extraction piston and the passage opening (conical-cylindrical, conical-curved, curved-curved, etc.) with the same positioning of the extraction piston.

The guide portion in this case is of a cross-sectional area that is equal to or greater than that of the flow braking portion, the conical or curved dosing portion being, at least on the extraction-piston end-region side—when the valve is fully open—of a cross-sectional area (flow cross-sectional area) that is equal to or less than that of the flow braking portion, thereby making it possible to realize a simplified structure as well as simplified manufacturing.

For the purpose of mounting the extracting and dosing valve securely on a head of the device for discharging the spray medium, the extraction orifice comprises a threaded portion, enabling the extracting and dosing valve to be easily screwed into a corresponding thread in the head of the device.

To ensure a long service life and to facilitate cleaning, the extraction piston and the extraction orifice are made of plastic or metal, preferably high-grade steel.

A method for handling an extracting and dosing valve according to the invention comprises the following valve positions:
closed position, in which an extraction piston is arranged in a passage opening of an extraction orifice in such a way that a first sealing element arranged on the extraction piston bears against a sealing surface of the passage opening;
open position, in which the extraction piston is arranged in the passage opening of the extraction orifice in such a way that a flow of a spray medium between an extraction surface of the extraction orifice and the extraction piston is ensured. In this case, the open position comprises a dosing position and a throttling position as follows:
dosing position or dosing region, in which the extraction piston is arranged in the passage opening of the extraction orifice in such a way that a dosing portion of the extraction piston is arranged in the region of the extraction surface of the extraction orifice;
throttling position, in which a flow braking portion of the extraction piston is arranged in the passage opening of the extraction orifice in such a way that a reduced flow of the spray medium between the extraction surface and the extraction piston is ensured.

In a further aspect of the invention, the present invention relates to a head for a device for discharging spray media, comprising an extracting and dosing valve according to the invention.

The head comprises:
a head body,
an actuating element, designed for handling the extracting and dosing valve,
a hold-down device in which an extraction piston of the extracting and dosing valve is arranged so as to be linearly movable,
the extraction piston comprising an extraction-piston stop that delimits a closed position of the extracting and dosing valve,
wherein a spring element surrounding the extraction piston is arranged in the hold-down device between the extraction-piston stop and a spring stop of the hold-down device, for fixing the closed position when the extracting and dosing valve is in the non-actuated state;
a gas supply unit, by means of which gas filling from a gas capsule of the head, or of the device, is effected, as well as
a spout nozzle for discharging the spray medium foamed with a gas,
an extraction orifice of the extracting and dosing valve being integral with the head body or such that it can be screw-connected to the head body by means of a threaded portion of the extraction orifice arranged on the actuating element side.

In one embodiment, the head body is at least partially surrounded by a head casing, which is preferably thermally insulating and/or has anti-slip elements to ensure a better grip. A head casing designed in this way can be useful, in particular, when dealing with liquid foodstuffs in order to prevent any slipping out of the hand.

In one embodiment, the actuating element is realized as a lever, the lever being mounted so as to be rotatable about an axle pin arranged in the region of a mount, the lever being supported on a slide element that is arranged at the head end of the extraction piston and opposite an end region of the extraction piston, in such a way that, upon the lever being actuated, it slides on the slide element, such that the extraction piston, which is guided approximately perpendicularly to the lever by means of a third and fourth sealing element, is moved in the direction of actuation of the lever. By means of such a lever-like actuating element, it is possible for the user of the device to achieve an almost uniform discharge of the spray medium, as well as targeted control of the discharge medium.

In a further aspect of the invention, the present invention relates to a device for discharging spray media, comprising a head that has an extracting and dosing valve according to the invention. The device comprises the following constituent parts:
a container on which a head body of the head is arranged when in use as intended, a non-return seal being arrangeable between the head body and the container;
a gas supply unit, by means of which a gas flow is effected from a gas capsule, which can be arranged in a gas-capsule holder, into the head, or into the device;
a tubular riser pipe that is provided in the interior of the container and is arrangeable on a riser-pipe mount of the head body by means of a riser-pipe fastening,
the riser pipe being coupled to the extracting and dosing valve via the riser-pipe mount of the head body.

The use of a non-return seal prevents the spray medium from emerging abruptly, or uncontrollably, in the event of any failure of the extracting and dosing valve. The riser pipe serves to convey the spray medium.

In one embodiment, both the riser pipe and the passage opening of the extraction orifice of the extracting and dosing valve are on the same axis, so that any flow losses, or flow resistance, can be avoided.

### BRIEF DESCRIPTION OF THE FIGURES

The invention will now be explained in greater detail on the basis of exemplary embodiments. The figures show examples, and are intended to illustrate the concept of the invention, but in no way to restrict it or even to represent it exhaustively. Further advantageous designs, details and developments of the invention are also shown in the figures, in which:

FIG. 1 shows a sectional representation of a head with an extracting and dosing valve according to an embodiment the invention in a closed position;

FIG. 2 shows an enlarged detail representation A of the extracting and dosing valve from FIG. 1;

FIG. 3 shows a sectional representation of the head with the extracting and dosing valve according to an embodiment the invention in a dosing position;

FIG. 4 shows an enlarged detail representation B of the extracting and dosing valve from FIG. 3;

FIG. 5 shows a sectional representation of the head with the extracting and dosing valve in a throttling position;

FIG. 6 shows an enlarged detail representation C of the extracting and dosing valve from FIG. 5;

FIG. 7 shows a sectional representation of the head with the extracting and dosing valve in a venting position;

FIG. 8 shows an enlarged detail representation D of the extracting and dosing valve from FIG. 7;

FIG. 9 a sectional representation of a first embodiment of an extraction orifice;

FIG. 10 shows a sectional representation of a second embodiment of the extraction orifice;

FIG. 11 shows a sectional representation of a third embodiment of the extraction orifice;

FIG. 12 shows a sectional representation of a fourth embodiment of the extraction orifice;

FIG. 13 shows a perspective representation of the fourth embodiment of the extraction orifice according to the embodiment from FIG. 12;

FIG. 14 shows a sectional representation of a fifth embodiment of the extraction orifice;

FIG. 15 shows a perspective representation of the fifth embodiment of the extraction orifice according to the embodiment from FIG. 14;

FIG. 16 shows a side view of a first embodiment of an extraction piston;

FIG. 17 shows a side view of a second embodiment of the extraction piston;

FIG. 18 shows a sectional representation of a device for discharging spray media comprising an embodiment of the extracting and dosing valve;

FIG. 19 shows a sectional representation of an actuating unit for the device for extracting spray media;

FIG. 20 shows a sectional representation of the device (without actuating unit) for extracting spray media comprising an embodiment of the extracting and dosing valve.

### DETAILED DESCRIPTION

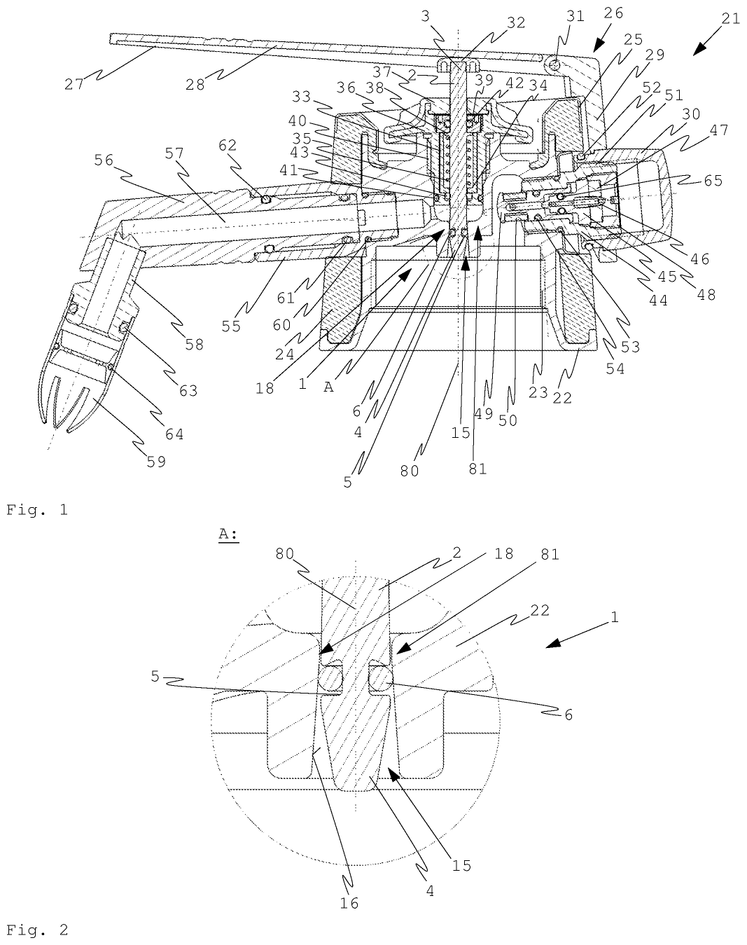

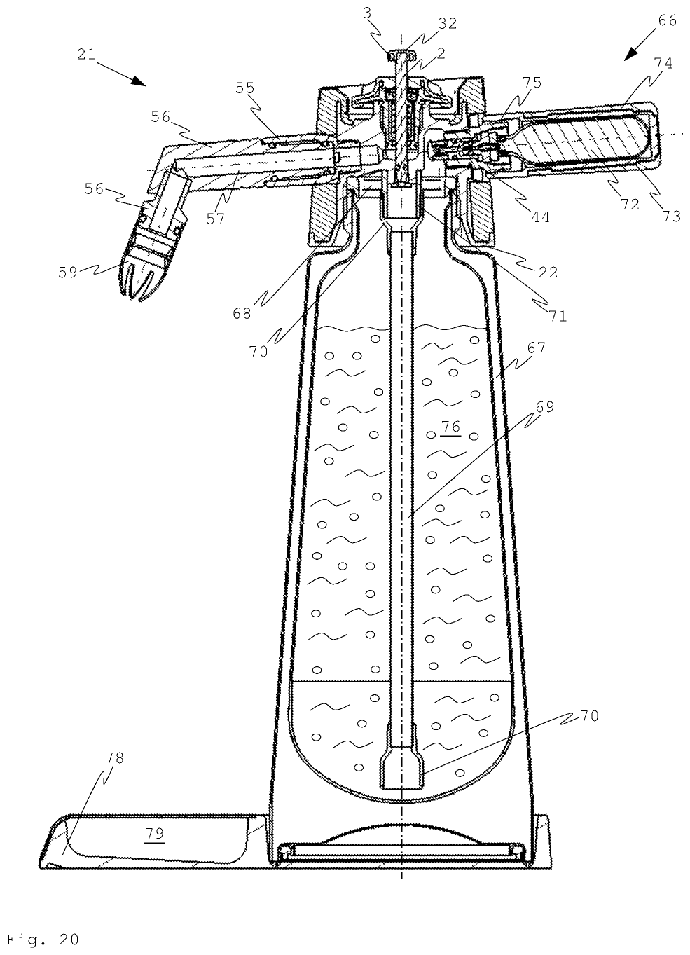

FIG. 1 shows a sectional representation of a head 21 with an extracting and dosing valve 1 according to an embodiment the invention, in a closed position, for a device 66 (see FIG. 18 and FIG. 20) for discharging fluids, preferably whipped cream or the like, the head 21 being such that it can be screwed onto a container 67 of the device 66 by means of a first threaded connection 23. Serving a main elements of the head 21 are a head body 22, a spout nozzle 55, an actuating unit 26, a gas supply unit 44, and the extracting and dosing valve 1, with the extracting and dosing valve 1 to be operated by means of an actuating element 27 that is preferably realized as a lever, preferably having an actuating-element cover 28 for ensuring a better grip. A head casing 24, which preferably surrounds, or encloses, large parts of the head 21, serves on the one hand to ensure a better grip, or to facilitate the handling of the head 21, and on the other hand as thermal insulation in the form of protection against heat and cold.

In detail, the extracting and dosing valve 1 is based on a slider principle, i.e. that an extraction piston 2 is arranged so as to be able to slide longitudinally inside a hold-down device 33 of the head 21, a spring element 35 being arranged between a spring stop 34 of the hold-down device 33 and an extraction-piston stop 38 inside the hold-down device 33 in such a way that the extracting and dosing valve 1 is closed by means of a first sealing element 6 when in the non-actuated state of the actuating element 27, i.e. in the initial position.

The extraction piston 2 comprises a longitudinal axis 80 defining an axial direction of the extraction piston 2 and, in general, of the extracting and dosing valve 1.

The actuating element 27 of the actuating unit 26 is rotatably connected to a mount 29 via an axle pin 31, with a fastening element 30, which is arranged so that it can be screwed to the gas-supply unit body 44 by means of a third threaded connection 51, serving to arrange the mount 29 on the head 21. A connection element 52 serves to connect the fastening element 30 to the mount 29. To ensure a reliable lever action and to protect the head casing 24, the latter has a head-casing cover 25 on the lever side, on which the mount 29 is supported.

For delivering the fluid, a spout-mount support 56 that has a medium outlet channel 57 is preferably arranged in a fluid-tight manner, by means of an eighth and a ninth sealing element 61, 62, on the spout nozzle 55, and a spout mount 58 with a spout 59 can be arranged on this medium outlet channel 57. In this case, in one embodiment there is also a tenth sealing element 63 arranged between the spout mount 58 and the spout 59, and for ease of cleaning the spout is a detachable spout 59 having a deflector and a separate, tenth sealing element 64. The spout nozzle 55, which is preferably screwed into the head 21, also has a seventh sealing element 60 to ensure a fluid-tight connection.

While the actuating element 27 is being pressed in the direction of the head 21, it slides on an extraction-piston actuating region 3, or a slide element 32, of the extraction piston 2 that protrudes from the head 21, while the extraction piston 2 is pushed axially in the direction of the head 21, or into the head 21, as a result of which the spring element 35, which is preferably realized as a compression spring, is compressed between the spring stop 34 of the hold-down device 33 and the extraction-piston stop 38. The further the extraction piston 2 is pushed into the head 21, the further the extraction and dosing valve 1, or a passage opening 15, is opened (and the spring element 35 is compressed), since the first sealing element 6 arranged on the extraction piston 2 is further away from a sealing surface 18 formed by the head body 22.

The passage opening 15 is delimited radially outwardly by the sealing surface 18 on the actuating element side and an extraction surface 16 on the discharge side that adjoins it in the axial direction. Radially inwardly, the passage opening 15 is delimited by the extraction piston 2.

The passage opening 15 is thus an annular opening, the cross-sectional area of which is formed by the differential area between the preferably conically extending sealing surface 18 and the cross-sectional area of the cylindrical extraction piston 2. It is to be noted that the cross-sectional area of the passage opening 15 may be not only circular or annular, but alternatively of any other shape. For easier arranging of the sealing element 6 in an extraction-piston groove 5, the extraction-piston end region 4 is preferably conical, the extraction-piston end portion 4 tapering in the direction of the container 67 (see FIG. 18 and FIG. 20). In contrast, the sealing surface 18 tapers on the actuating region side, i.e. in the opposite direction to the extraction-piston end region 4.

The passage opening 15 is part of the head body 22 and is realized in an extraction orifice 81 integrated into the head body 22.

The gas supply unit 44 comprises a pressure-limiting valve comprising a non-return valve piston 49 and a non-return valve seal 50, a piercing pin 46 for piercing a membrane of a gas capsule (not represented) being arranged in a piercing-pin holder 45, a retaining ring 48 being provided for centering the gas capsule and for fastening a deflection plate 47 for the gas capsule. The pressure relief valve in this case has a fifth and a sixth sealing element 53, 54, the piercing-pin holder 45 also comprising a twelfth sealing element 65 for gas-tight connection to the pressure-limiting valve. In this case, the non-return valve piston 49 in combination with the piercing-pin holder 45 and the sixth sealing element 54, as well as the twelfth sealing element 65, forms a pressure-limiting valve for limiting the pressure in the interior of the appliance, this pressure being generated substantially by the gas flowing from the gas capsule into the interior of the appliance. The gas capsule is only screwed to the gas supply unit at the beginning, for the purpose of supplying gas to the device 66, and is removed from the device 66 before the latter is used.

The hold-down device 33 is arranged within an extraction-unit body 36, an extraction-unit casing 37 serving to seal the extraction-unit body 36 on the lever side, the extraction-unit body 36 being screw-connected to the head body 22 by means of a second threaded connection 40, and a second sealing element 41 being sealed to the head body 22. In this case, the extraction-unit body 36, which like the hold-down device is preferably rotationally symmetrical, as well as the extraction-unit casing 37, has a through-bore, the extraction piston 2 being mounted so as to be longitudinally displaceable through the latter, a fourth sealing element 43 being arranged around the extraction piston 2, between the hold-down device 33 and the extraction-unit body 36. The extraction-unit casing 37 surrounds the extraction-unit body 36 for easier handling as well as for protection against possible contamination. An extraction-piston screwed connection 39 serves to fix and guide the extraction piston 2, to preload the spring element 35 and to fix, or position, the hold-down device 33, a third sealing element 42 serving to guide the extraction piston 2 and to protect the hold-down device 33 from possible contamination.

It is to be noted at this point that all sealing elements 6, 41, 42, 43, 53, 54, 60, 61, 62, 63, 64, 65 are preferably realized as O-rings.

FIG. 2 shows an enlarged detail representation A of the extracting and dosing valve from FIG. 1. It can be seen clearly here that, in one embodiment, the extracting and dosing valve 1 is realized as part of the head body 22. In this case, the extracting and dosing valve 1 has a conical inner surface that is composed of the sealing surface 18 on the head side, or actuating-element side, and the extraction surface 16 on the container side, or base side, or discharge side, the conical inner surface widening on the container side such that the sealing surface 18 has a smaller diameter than the extraction surface 16. Arranged within this conical inner surface there is at least a part of the extraction piston 2, which has an extraction-piston groove 5 in which a first sealing element 6 is arranged. When the extracting and dosing valve 1 is in the closed state, the first sealing element 6 is arranged on the sealing surface 18, such that the passage opening 15 is closed.

As a result of the extraction piston 2 being displaceable longitudinally, it can be displaced in the direction of the container 67 (see FIG. 18 and FIG. 20), as a result of which the extracting and dosing valve 1 is opened, thereby opening the passage opening 15, which is annular in cross-section. For easier arrangement of the first sealing element 6, the extraction piston 2 has a cone-shaped extraction-piston end region 4, enabling the first sealing element 6 to be more easily arranged in the extraction piston groove 5.

FIG. 3 shows a sectional representation of the head 21 with the extracting and dosing valve 1 in a dosing position. It can be seen in detail that the actuating element 27, which is preferably realized in the manner of a lever, has been slightly actuated, such that the extraction piston 2 is arranged further in the direction of the container 67 (see FIG. 18 and FIG. 20), as a result of which the extracting and dosing valve 1 is open because the first sealing element 6 is not bearing against the sealing surface 18.

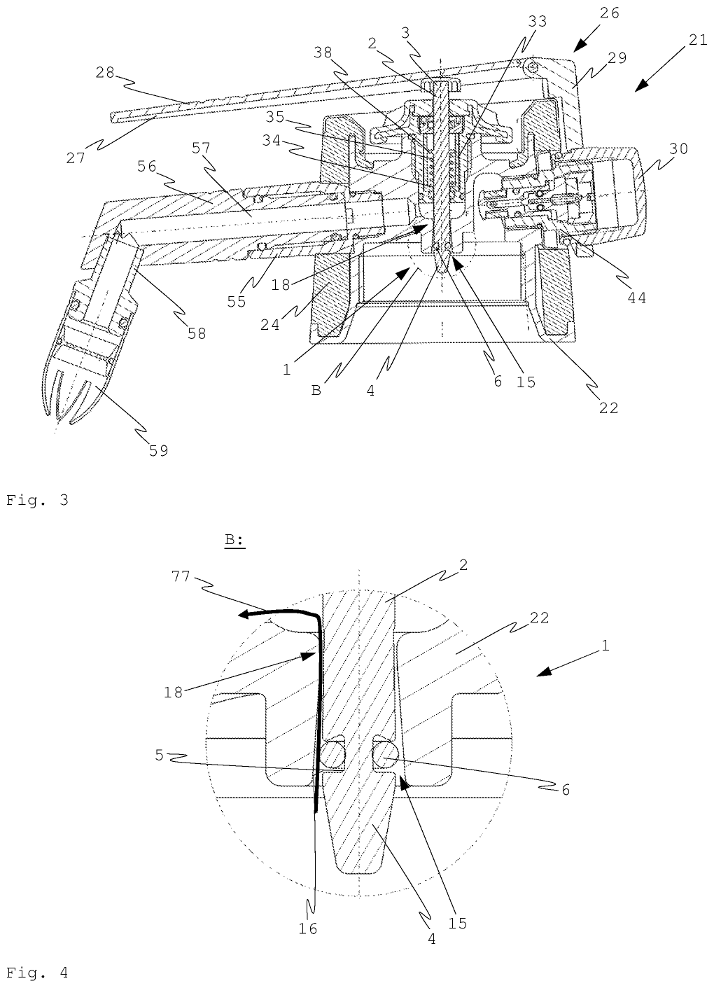

FIG. 4 shows an enlarged detail representation B of the extracting and dosing valve from FIG. 3. It can be seen clearly here that the extracting and dosing valve 1 is open because the first sealing element 6 is not bearing against the sealing surface 18, as a result of which the annular passage opening 15 is open. This results in the opening of a flow path 77 for the extraction of a spray medium 76 from the container 67 (see FIG. 18 and FIG. 20), as represented by an arrow. In detail, due to the conical or cylindrical shape of the extraction piston 2 and the oppositely directed conical shape of the inner surface 18, 16 of the extracting and dosing valve 1, the passage opening 15 is likewise conical, the passage opening 15 having a larger outer diameter in the area of the extraction surface 16 than in the region of the sealing surface 18.

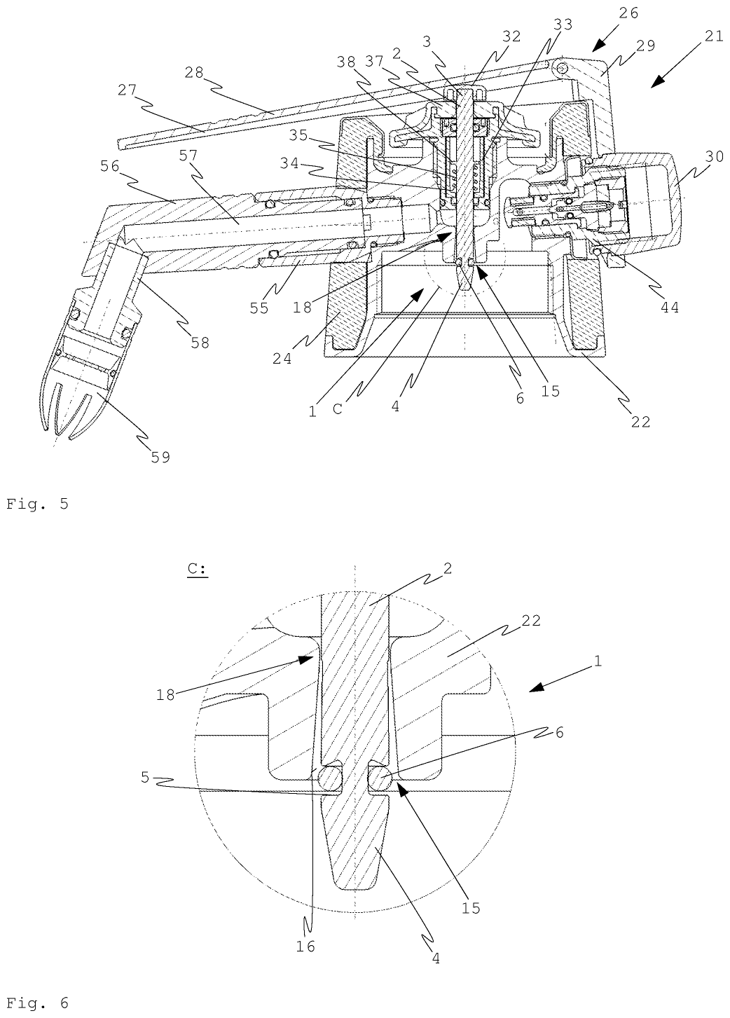

FIG. 5 shows a sectional representation of the head 21 with the extracting and dosing valve 1 in a throttling position. In this position, the extraction piston 2 is arranged even further in the direction of the container 67 (see FIG. 18 and FIG. 20), which can be achieved by more forceful actuation of the lever-like actuating element 27. In other words, the actuating element 27 is pushed so far toward the container 67 that the sliding element 32, which is arranged on the extraction-piston actuating region 3, rests on the extraction-unit casing 37, or almost on the extraction-unit casing 37.

FIG. 6 shows an enlarged detail representation C of the extracting and dosing valve from FIG. 5. Here, the extracting and dosing valve 1 is open, because the first sealing element 6 is not bearing against the sealing surface 18, as a result of which the annular passage opening 15 is open. Spray medium 76 can again emerge from the container 67 (see FIG. 18 and FIG. 20).

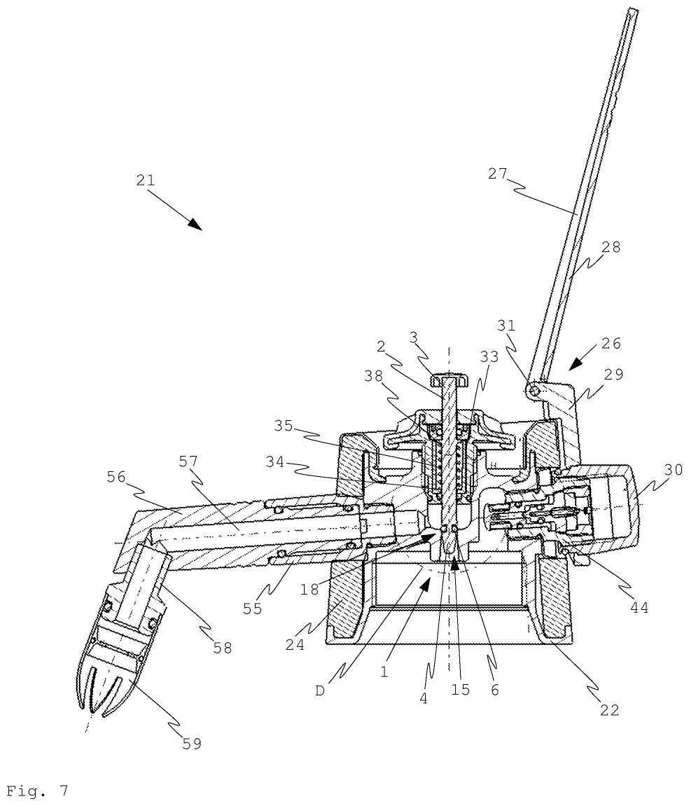

FIG. 7 shows a sectional representation of the head 21 with the extracting and dosing valve 1 in a venting position. This means that the lever-like actuating element 27 does not rest on the slide element 32, but is folded up via the axle pin 31 in such a way that the extraction piston 2 can be freely removed for cleaning the extracting and dosing valve 1.

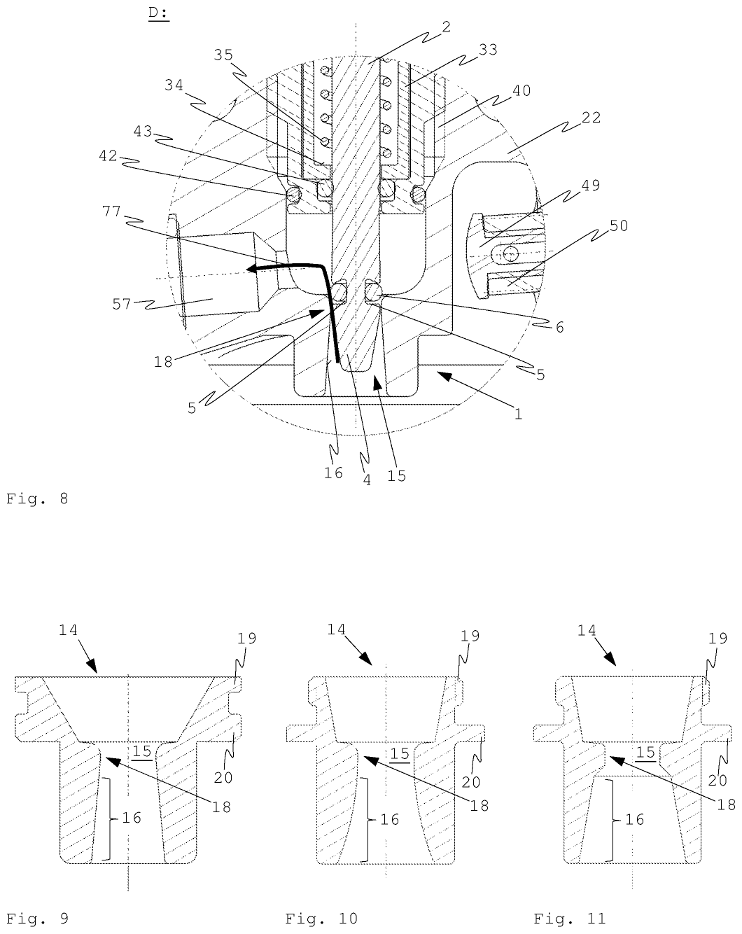

FIG. 8 shows an enlarged detail representation D of the extracting and dosing valve 1 from FIG. 7, a flow path 77 also being represented here by means of an arrow (see FIG. 18 and FIG. 20). In detail, the extraction piston 2 is arranged in the direction of the head 21, such that the extracting and dosing valve 1 is open, because the first sealing element 6 is not bearing against the sealing surface 18.

The possibility for gas to escape in the venting position serves to realize a safety function that ensures that any gas still contained in the container escapes upon, or during, detachment of the extraction-unit body 36 from the head body 22, such that any abrupt separation of the extraction-unit body 36 from the head body 22 caused by excess or residual pressure can be avoided.

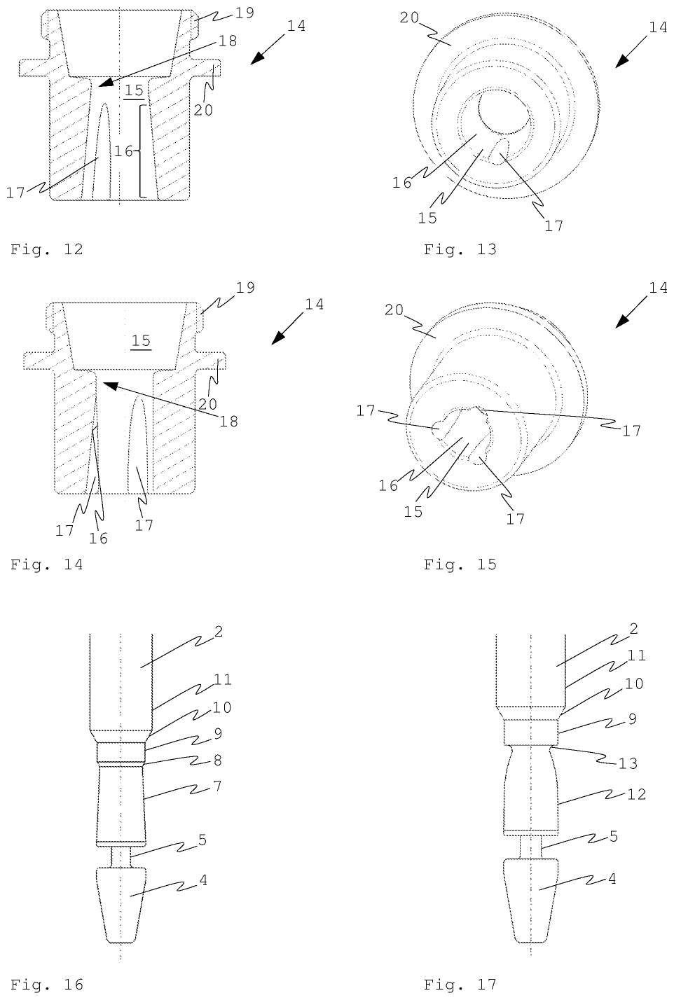

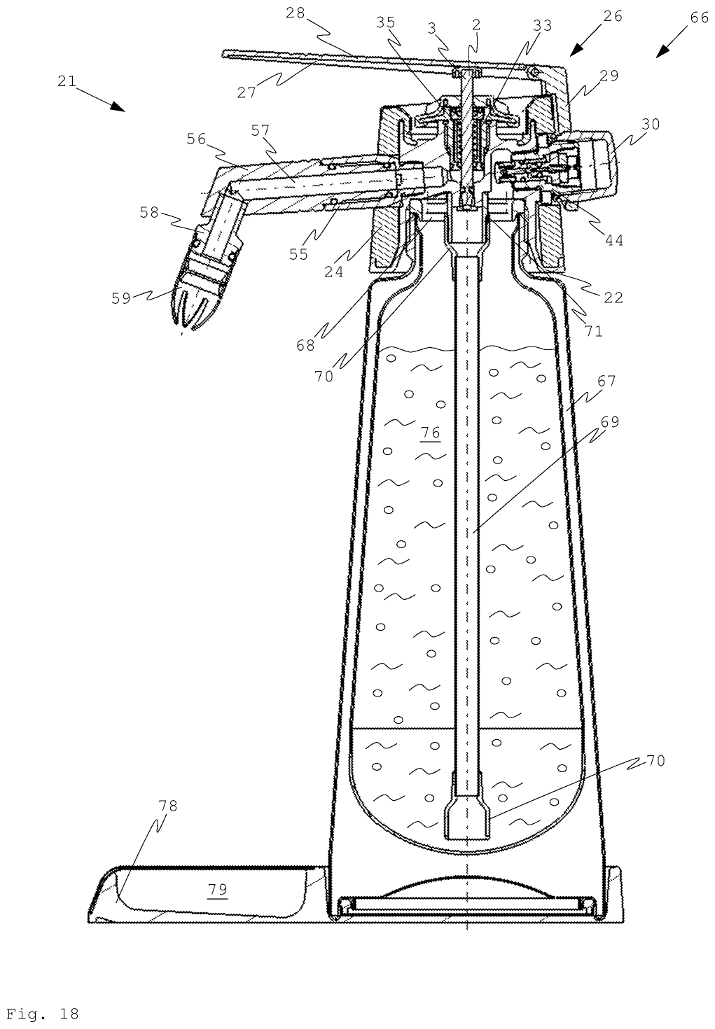

In an alternative embodiment, it is provided that the extracting and dosing valve 1 is not realized as part of the head body 22, but as a separate, completely replaceable component. In this respect, FIG. 9, FIG. 10, FIG. 11, FIG. 12 and FIG. 14 each show a sectional representation of different embodiments of an extraction orifice 14 that can be screwed into the head body 22 by means of a threaded portion 19, such that variously designed shapes of extraction surfaces 16 and sealing surfaces 18 can be realized for any applications, or any shapes of passage openings 15.

For this purpose, the extraction orifice 14 is screwed into the head body 22 as far as a stop 20, a sealing element (not represented), preferably in the form of an O-ring, preferably being arranged between the stop 20 and the threaded portion 19. In this regard, FIG. 9 shows a cone-shaped inner surface, FIG. 10 shows a conical-convex inner surface (as viewed from the passage opening 15), and FIG. 11 shows a frusto-conical inner surface, the sealing surface 18 in FIG. 11 being cylindrical.

In FIG. 12 and FIG. 14 the inner surface is conical in each case, there being at least one, preferably slot-shaped, recess 17 arranged in the region of the extraction surface 16. The extraction surface 16 of the extraction orifice 14 represented in FIG. 12 and FIG. 13 has only one recess 17, whereas the extraction orifice 14 represented in FIG. 14 and FIG. 15 has three recesses 17 arranged symmetrically, i.e. 120 degrees apart. By means of such recesses, the discharge, or the shape of the discharge, of the spray medium 76 can be additionally influenced.

Recesses corresponding to the recesses 17 of FIGS. 12-15 may also be provided in the exemplary embodiment of FIGS. 1-8 in the region of the inner surface 16 of the extracting orifice 81 of the extracting and dosing valve 1.

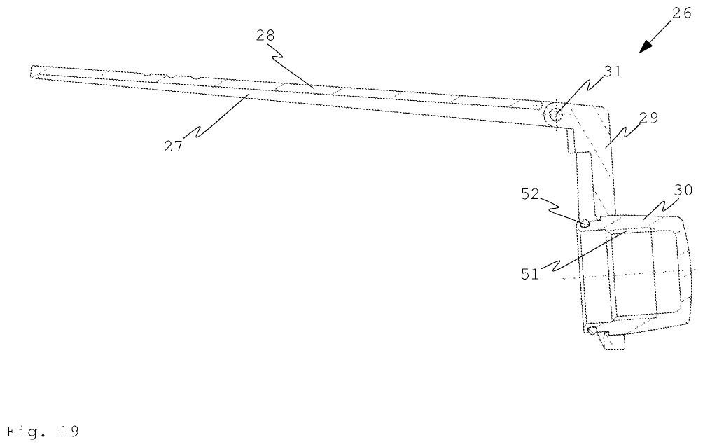

FIG. 16 shows a side view of a further embodiment of the extraction piston 2, the extraction-piston end region 4 being conical according to the above explanations for easier arrangement of the first sealing element 6, which is preferably arranged in an extraction-piston groove 5. In order to ensure additional control of the volume flow of the spray medium 76, the extraction piston 2 represented in FIG. 16 is not purely cylindrical, but is realized as a rod-shaped rotational solid. In this case, the extraction piston 2 has a conically tapering dosing portion 7 adjoining the extraction-piston groove 5, thereby providing for continuous control of the volume flow of the spray medium 76. Adjoining the dosing portion 7, the extraction piston 2 has a stepped flow brake portion 9 that serves to throttle the volume flow, a first transition region 8 in the form of a bevel being arranged therebetween. Adjoining the flow brake portion 9 on the actuating element side here is a second transition region 10 in the form of a bevel, which adjoins a guide portion 11 of the extraction piston 2.

FIG. 17 shows a further embodiment of an extraction piston 2 which has the same basic structure as the extraction piston 2 represented in FIG. 16, but the extraction piston 2 has a curved dosing portion 12, which provides for discontinuous control of the volume flow of the spray medium 76.

FIG. 18 shows a sectional representation of a device 66 for discharging spray media 76 comprising the extracting and dosing valve 1 which is arranged in the head 21 of the device 66. In detail, the head 21 is screwed onto a container 67 by means of the first threaded connection 23, and in addition a riser pipe 69 may be arranged on the head 21 via a riser-pipe 70 that, for easier handling, is arranged at both ends of the riser pipe 69. For this purpose, on the container side the head has a riser-pipe mount 71 that surrounds the extracting and dosing valve 1 so as to ensure that the spray medium 76 to be discharged flows through the extracting and dosing valve 1. In addition, it is conceivable for the device 66 to comprise a drip unit 78 with a collecting tray 79.

FIG. 19 shows a sectional representation of the actuating element 26 for the device 66 for discharging spray media 76, which is detachable from the head 21, the actuating element 27, preferably realized as a lever, being arranged on the mount 29 via the axle pin 31. In this case, the actuating element 27 comprises the actuating-element cover 28 to provide a better grip. The mount 29 comprises a hole-type recess through which the mount 29 can be arranged by means of the fastening element 30 on the head 21, or on the head body 22, via the third threaded connection 51, with preferably an annular connection element 52 surrounding the preferably cap-shaped fastening element 30 on the opening side. Here, the connection element 52 is preferably realized as an O-ring in order to ensure additional tightness.

FIG. 20 shows a sectional representation of the device 66 (without actuating unit 26) for discharging spray media 76, there being a gas capsule 72 arranged on the device for supplying gas to the device, or to the spray medium 72 to be discharged. In detail, for the purpose of supplying gas to the spray medium 72, it is provided that, in a first step, the actuating unit 26 is removed and, in a next step, the gas capsule 72 is arranged on the gas supply unit 44 by means of a gas-capsule holder 73 by means of a fourth threaded connection 75. To ensure a better grip, the gas-capsule holder 73 has a gas-capsule holder cover 74. After the supplying of gas has been completed, the gas-capsule holder 73, together with the gas capsule 72, is unscrewed and the actuating unit 26 is again arranged on the head 21.

It is furthermore pointed out that the features of the individually described exemplary embodiments of the invention can be combined in various combinations with one another. Where areas are defined, they include all the values within these areas and all the sub-areas falling within an area.

What is claimed is:

1. An extracting and dosing valve for a device for discharging spray media, comprising:
an extraction piston having a longitudinal axis that comprises an extraction-piston actuating region and an axially oppositely arranged extraction-piston end region, an extraction orifice comprising a passage opening in which the extraction piston is arranged so as to be movable linearly, the extracting and dosing valve having a closed state that corresponds to a defined position of the extraction piston,
a first sealing element arranged adjoining the extraction-piston end region on the actuating region side, wherein the first sealing element closes the passage opening when the extracting and dosing valve is in the closed state,
wherein the passage opening is delimited radially outwardly by a sealing surface on the actuating element side and by an extraction surface axially adjoining axially it on the discharge side, which together form an inner surface of the extraction orifice, the first sealing element bearing at least partially against the sealing surface when the extracting and dosing valve is in the closed state, and
wherein the sealing surface arranged on the actuating element side has a lesser cross-sectional area than the extraction surface arranged on the discharge side.

2. The extracting and dosing valve as claimed in claim 1, wherein when the extracting and dosing valve, which can be regulated by means of an actuating element arranged on the extraction-piston actuating region, is in the closed state, at least part of the extraction-piston end region is located within the passage opening.

3. The extracting and dosing valve as claimed in claim 1, wherein both the sealing surface and the extraction surface of the extraction orifice, as well as the extraction piston, have the same cross-sectional shape.

4. The extracting and dosing valve as claimed in claim 1, wherein the extraction surface is conical, conically domed or conically convex for the purpose of regulating a flow of the spray medium between the passage opening and the extraction piston.

5. The extracting and dosing valve as claimed in claim 1, wherein the extraction-piston end region is conical.

6. The extracting and dosing valve as claimed in claim 1, wherein the first sealing element is arranged in an extraction-piston groove that adjoins the extraction-piston end region.

7. The extracting and dosing valve as claimed in claim 1, wherein the extraction surface of the extraction orifice comprises at least one recess for regulation of the flow of the spray medium.

8. The extracting and dosing valve as claimed in claim 7, wherein the at least one recess is flat, slot-shaped, or cylindrical.

9. The extracting and dosing valve as claimed in claim 1, wherein the extraction piston comprises a guide portion arranged on the extraction-piston actuating-region side, there being arranged, between the extraction-piston end region and the guide portion, a dosing portion on the extraction-piston end-region side and a flow braking portion on the guide-portion side.

10. The extracting and dosing valve as claimed in claim 9, wherein the dosing portion is tapered conically or in a curved manner toward the guide portion.

11. The extracting and dosing valve as claimed in claim 9, wherein the guide portion is of a cross-sectional area that is equal to or greater than that of the flow braking portion, the conical or curved dosing portion being, at least on the extraction-piston actuating-region side, of a cross-sectional area that is equal to or less than that of the flow braking portion.

12. A head for a device for discharging spray media, comprising an extracting and dosing valve as claimed in claim 1, comprising:
a head body,
an actuating element configured to handle the extracting and dosing valve,
a hold-down device in which an extraction piston of the extracting and dosing valve is arranged so as to be linearly movable,
the extraction piston comprising an extraction-piston stop that delimits a closed position of the extracting and dosing valve,
wherein a spring element surrounding the extraction piston is arranged in the hold-down device between the extraction-piston stop and a spring stop of the hold-down device, for fixing the closed position when the extracting and dosing valve is in the non-actuated state;
a gas supply unit which is configured to effect a gas filling from a gas capsule of the head, or of the device; and
a spout nozzle for discharging the spray medium foamed with a gas;
wherein an extraction orifice of the extracting and dosing valve is integral with the head body or such that it can be screw-connected to the head body by means of a threaded portion of the extraction orifice arranged on the actuating element side.

13. The head of claim 12, wherein the spring element is in the form of a compression spring or a rubber buffer.

14. A device for discharging spray media, comprising a head as claimed in claim 12 that comprises an extraction and dosing valve as claimed in claim 1, comprising:
a container on which a head body of the head is arranged when in use as intended, a non-return seal being arrangeable between the head body and the container;
a tubular riser pipe that is provided in the interior of the container and is arrangeable on a riser-pipe mount of the head body by means of a riser-pipe fastening,
the riser pipe being coupled to the extracting and dosing valve via the riser-pipe mount of the head body;
wherein the gas supply unit is configured to effect a gas flow from the gas capsule into the head, or into the device.
